(19) United States
(12) Patent Application Publication
(10) Pub. No.: US 2025/0356542 A1
(43) Pub. Date: Nov. 20, 2025

(54) INFORMATION PROCESSING APPARATUS CAPABLE OF SWITCHING IMAGES ACCORDING TO POSITION DESIGNATED BY USER, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: SEISHIRO IWAHORI, Tochigi (JP)

(21) Appl. No.: 19/207,810

(22) Filed: May 14, 2025

(30) Foreign Application Priority Data
May 14, 2024 (JP) 2024-078469

(51) Int. Cl. G06T 11/00

(52) U.S. Cl. CPC G06T 11/00

(57) ABSTRACT

An information processing apparatus capable of easily switching and displaying a real image and a pseudo image. The information processing apparatus includes a memory device storing instructions, and a processor executing the instructions to: obtain a current position of a user, present positions including the current position with a display device, designate a position from among the positions in accordance with a user's instruction, display an image obtained by an image capturing device capturing a real space as a real image indicating a visual field of the user at the current position on the display device when the designated position is the current position, and display a pseudo image generated by resembling a visual field of the user at the designated position on the display device when the designated position is not the current position.

### BACKGROUND

### Cross-Reference to Priority Application

This application claims the benefit of Japanese Patent Application No. 2024-078469, filed May 14, 2024, which is hereby incorporated by reference herein in its entirety.

### FIELD OF THE TECHNOLOGY

The present disclosure relates to an information processing apparatus capable of switching images according to a position designated by a user, a control method therefor, and a storage medium storing a control program therefor.

### DESCRIPTION OF THE RELATED ART

In recent years, there has been remarkable innovation in MR (Mixed Reality) technology. In addition, technological innovation popularizes MR devices such as an HMD (Head Mounted Display). The HMD is utilized in various MR contents, such as sharing of a completion image in a construction site and presentation of CG (Computer Graphics) of a new product in an exhibition hall. In an MR content providing such a mixed reality space, when a user wants to change a position at which the user views a virtual object, the user moves on foot in the main. However, from a viewpoint of the user, it is troublesome for the user to move on foot every time the user repeats changing the position at which the user views the virtual object. As a technique related to this point, for example, Japanese Patent Laid-Open No. 2020-204973 discloses a technique of recording a panoramic image in association with a position and a posture in photographing, and generating and displaying a panoramic image viewed from a position where a user virtually walks around in accordance with a posture of a head of the user.

However, the technique disclosed in the above publication has a problem that although the panoramic image at the position where the user virtually walks around can be displayed, it is not easy to immediately return to the display of the panoramic image at the previous position.

### SUMMARY

The present disclosure provides a technique capable of easily switching and displaying a real image indicating a visual field of a user at a current position and a pseudo image resembling a visual field of the user at a designated position.

Accordingly, an aspect of the present invention provides an information processing apparatus including a memory device that stores a set of instructions, and at least one processor that executes the set of instructions to: obtain a current position of a user, present a plurality of positions including the current position with a display device, designate a position from among the plurality of positions in accordance with an instruction from a user, display an image obtained by an image capturing device capturing a real space as a real image indicating a visual field of the user at the current position on the display device in a case where the position designated is the current position, and display a pseudo image generated by resembling a visual field of the user at the position designated on the display device in a case where the position designated is not the current position.

Further features of the present invention will become apparent from the following description of exemplary embodiments with reference to the attached drawings.

### BRIEF DESCRIPTION OF THE DRAWINGS

FIG. 1A is an image diagram illustrating a common feature in embodiments of the present disclosure.

FIG. 1B is another image diagram illustrating a common feature in the embodiments of the present disclosure.

FIG. 2 is a block diagram illustrating an example of a common hardware configuration of an HMD in the embodiments.

FIG. 3 is a block diagram illustrating a functional configuration of an HMD in a first embodiment.

FIG. 4 is a view illustrating examples of data combinations each in which position-and-posture information and an image in a real space (hereinafter referred to as a “real image”) are mutually associated in position-posture-and-image information in the HMD in the first embodiment.

FIG. 5A is a view illustrating an example of a scene in which a display content is switched in the HMD in the first embodiment.

FIG. 5B is a view illustrating an example of a screen when a real image at a current position is displayed on a display device of the HMD in the first embodiment.

FIG. 5C is a view illustrating an example of a screen when a pseudo image at a position B is displayed on the display device of the HMD in the first embodiment.

FIG. 6A is a view illustrating an example of a method of designating a position with a position designation module in the HMD in the first embodiment.

FIG. 6B is a view illustrating another example of the method of designating the position with the position designation module in the HMD in the first embodiment.

FIG. 7 is a flowchart illustrating a process to record position-and-posture information and a real image in position-posture-and-image information in the HMD in the first embodiment.

FIG. 8 is a flowchart illustrating a process to switch a display content between a real image and a pseudo image in the HMD in the first embodiment.

FIG. 9 is a flowchart illustrating a process to switch a display content between the real image and the pseudo image in the HMD in the first embodiment and to be specialized for a case where a position is designated by a gesture of a user.

FIG. 10 is a block diagram illustrating a functional configuration of an HMD in a second embodiment.

FIG. 11 is a flowchart illustrating a process to switch a display content between a mixed reality image and a mixed pseudo image in the HMD in the second embodiment.

FIG. 12 is a flowchart illustrating a process to display the mixed reality image in the second embodiment.

### DESCRIPTION OF THE EMBODIMENTS

Hereafter, embodiments according to the present invention will be described in detail by referring to the drawings. However, the configurations described in the following embodiments are merely examples, and the scope of the present disclosure is not limited by the configurations described in the embodiments. For example, each of the units constituting the present disclosure can be replaced with any unit that can exhibit the same function. In addition, an arbitrary constituent may be added. In addition, two or more arbitrary configurations (features) of the embodiments may be combined. In addition, all combinations of features described in each embodiment are not necessarily essential to the solution of the present disclosure. The configuration of each embodiment may be modified or changed as appropriate depending on the specifications of the apparatus to which the present disclosure is applied and various conditions (such as use conditions and use environment). In the following embodiments, the same reference numerals are given to the same components.

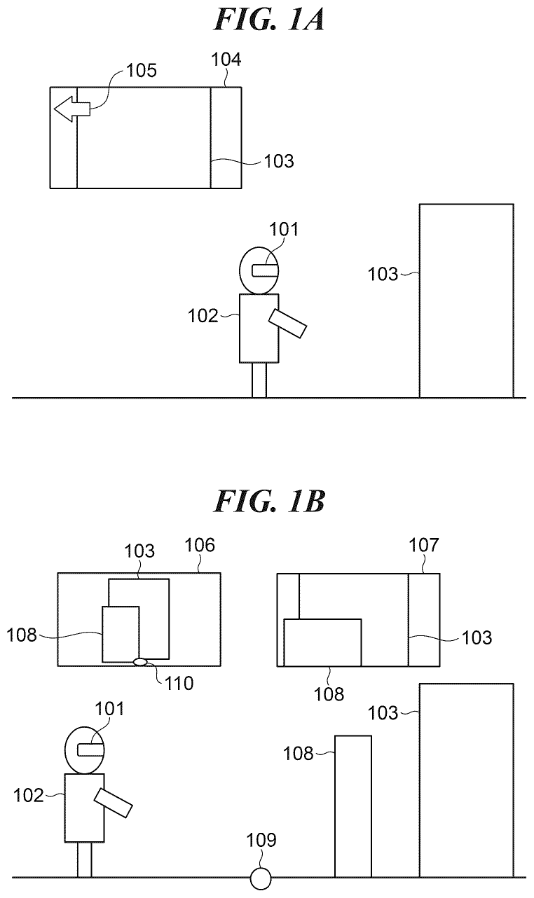

First, a configuration common to embodiments will be described with reference to the drawings. FIG. 1A and FIG. 1B are image diagrams illustrating common features of embodiments of the present disclosure. A video see-through HMD 101 is an information processing apparatus that can be worn on a head of a user 102. There is a shelf (hereinafter referred to as a “real object”) 103 actually in front of the user 102. The HMD 101 in the embodiments includes a capturing-and-displaying system and a processing system. On the other hand, when the HMD 101 is reduced in size and weight, the capturing-and-displaying system and the processing system of the HMD 101 may be separated. In such a case, the capturing-and-displaying system may be disposed in the HMD 101, while the processing system may be disposed in a small external box computer as an external apparatus. In such a configuration, the small external box computer corresponds to the information processing apparatus. The external apparatus is not limited to the small external box computer, and may be, for example, a portable computer such as a notebook PC, a tablet PC, or a smartphone, or a stationary computer such as a desktop PC.

FIG. 1A is the image diagram illustrating an example of a scene in which the user 102 obtains information about a position and a posture of the user 102 (hereinafter, also referred to as “position-and-posture information”) and an image at the position and the posture with a gyrosensor and a camera mounted on the HMD 101. In this case, the position-and-posture information about the user 102 can obtained with the gyrosensor when the HMD 101 is mounted on the head of the user 102. Therefore, the HMD 101 can obtain the information showing the position and the posture of the user 102 and the image captured at the position and the posture with the gyrosensor and the camera. The HMD 101 records the position-and-posture information and the image obtained in this manner in a storage device in association with each other.

An image 104 being captured by the camera mounted on the HMD 101 is being displayed on an electronic display mounted in the HMD 101 and shows a visual field of the user 102 wearing the HMD 101. An arrow 105 that the HMD 101 guides the user 102 to another posture is displayed in the image 104. The user 102 can record images in various postures at the current position in the HMD 101 by moving the head along the arrow 105.

FIG. 1B is the image diagram illustrating an example of a scene in which the user 102 switches an image displayed on the electronic display mounted in the HMD 101 from a mixed reality image 106 at a current position to a mixed pseudo image 107 at a designated position (a recording position 109 described later). The mixed reality image 106 is an image in a mixed real space viewed by the user 102 wearing the HMD 101 at the current position, and includes the real object 103, a three dimensional virtual object (hereinafter referred to as a “virtual object”) 108, and a mark 110 indicating a position (hereinafter referred to as a “recording position”) 109 of the user 102 indicated by the position-and-posture information recorded in association with the image as described above. The mixed pseudo image 107 is an image in a pseudo mixed real space in assuming that the user 102 wearing the HMD 101 views at the recording position 109, and includes the real object 103 and the virtual object 108. Note that the mixed pseudo image 107 does not include the mark 110 indicating the recording position 109 because the recording position 109 is not included in the mixed pseudo image.

When the user 102 designates the mark 110 by a controller or a hand tracking function of the HMD 101, the mixed reality image 106 at the current position is switched to the mixed pseudo image 107 at the recording position 109. Further, when the user 102 performs a gesture, such as waving of a hand, the mixed pseudo image 107 at the recording position 109 is switched to the mixed reality image 106 at the current position. Further, when the user 102 utters a position name indicating the recording position 109, the mixed reality image 106 at the current position is switched to the mixed pseudo image 107 at the recording position 109. In this way, the HMD 101 can switch a display content between the mixed reality image 106 at the current position and the mixed pseudo image 107 at the recording position 109. However, a first embodiment described later assumes a case where the virtual object 108 does not exist.

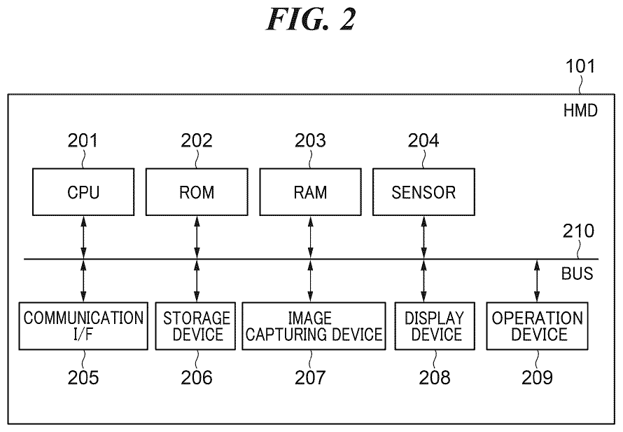

FIG. 2 is a block diagram illustrating an example of a common hardware configuration of the HMD in the embodiments. A CPU 201 is a system controller and controls the entire HMD 101. In addition, the CPU 201 achieves an information process according to the embodiments by executing an information processing program. A ROM 202 is a read only memory in which programs, parameters, and the like that do not need to be changed, such as a basic program and initial data, are stored. A RAM 203 is a memory to temporarily store input information, calculation results of the information process and an image process. A sensor 204 is a sensing component that detects a position and a posture of the HMD 101, that is, the position and the posture of the user 102, and is, for example, a gyrosensor.

A communication I/F 205 is an interface capable of transmitting and receiving data to and from an external apparatus, such as an external camera or a cloud. The communication I/F 205 inputs and outputs data via a local connection by USB (registered trademark) or Bluetooth (registered trademark) and an Internet connection by Ethernet (registered trademark) or Wi-Fi (registered trademark). A storage device 206 is capable of reading and writing various types of information. Specifically, the storage device 206 is a memory card, a removable disk, or an IC card that is detachable from the HMD 101, or a hard disk or a memory card that is built in or externally attached to the HMD 101.

The information processing program according to the embodiments shall be recorded in the storage device 206, read from the storage device 206, developed onto the RAM 203, and executed by the CPU 201. The information processing program may be stored in the ROM 202. The storage device 206 can also record required data used by the information processing program executed by the CPU 201. An image capturing device 207 is a camera mounted on the HMD 101, for example. A display device 208 is an electronic display mounted on the HMD 101, for example. The display device 208 has a configuration of a stereo display corresponding to both eyes of the user 102. An operation device 209 controls input to the HMD 101. The operation device 209 includes a power button, a menu button, a controller, etc. In the HMD 101, all the hardware configuration components are connected to a bus 210 and can communicate with each other.

An image capturing system and a processing system in the HMD 101 may be separated from the HMD 101 as external devices. In such a case, an information processing system can be constituted by the external devices and a display system (the display device 208) in the HMD 101. In such an information processing system, the image capturing system corresponding to the image capturing device 207 separated from the HMD 101 may be a camera held by the user 102 or a 360-degree camera.

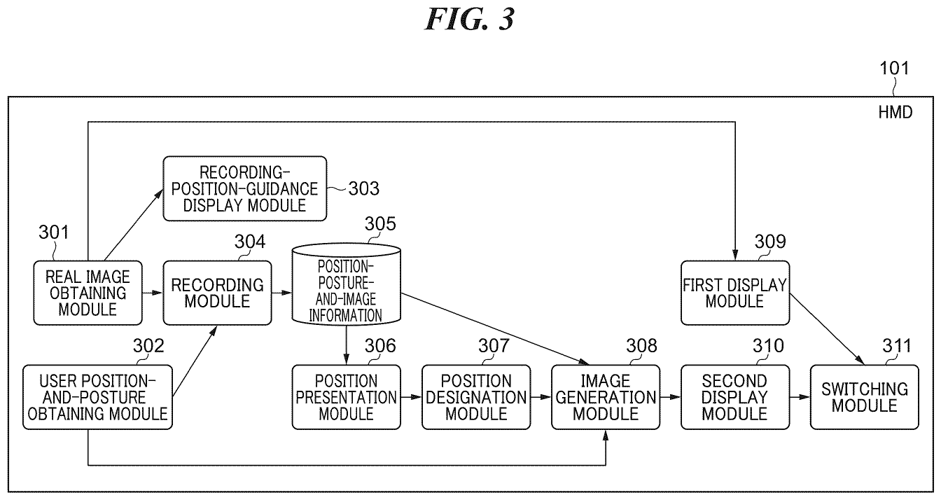

Hereinafter, a first embodiment will be described with reference to FIG. 3 to FIG. 9 in addition to FIG. 1 and FIG. 2 described above. FIG. 3 is a block diagram illustrating a functional configuration of the HMD 101 in the first embodiment. A real image obtaining module 301 obtains a real image with the image capturing device 207 in the HMD 101. The real image indicates a visual field of the user 102 at the current position. A user position-and-posture obtaining module 302 obtains position-and-posture information about the user 102 with the sensor 204 in the HMD 101. A recording-position-guidance display module 303 applies an image recognition technique to the real image obtained by the real image obtaining module 301, and displays a guidance about an image capturing position and an image capturing range to the user 102 when the recording module 304 records the real image. The arrow 105 is also displayed by the recording-position-guidance display module 303.

A recording module 304 obtains an image at the position and the posture indicated by the position-and-posture information obtained by the user position-and-posture obtaining module 302 from the real image obtained by the real image obtaining module 301, and records the image in position-posture-and-image information 305 in association with the position-and-posture information concerned. In this way, the position-posture-and-image information 305 having a plurality of data combinations each in which the position-and-orientation information and the real image are mutually associated is constructed as data sets by the recording module 304. The recording module 304 records data in the position-posture-and-image information 305 when the user 102 issues a recording start instruction or when the user 102 keeps the current position at the same position during a certain time period.

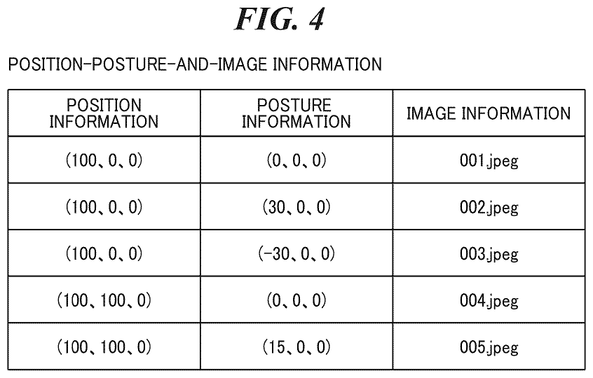

FIG. 4 is a view illustrating examples of data combinations each in which position-and-posture information and a real image are mutually associated in the position-posture-and-image information 305. In the position-posture-and-image information 305, a plurality of data combinations each in which the position-and-posture information about the user 102 and the real image that are mutually associated are recorded. Data of a real image is compressed in the JPEG format, and is represented by a file name as image information in FIG. 4. The position-and-posture information about the user 102 is recorded in the position-posture-and-image information 305 while being separated into the position information and the posture information. The position information is represented by a three dimensional coordinate (x, y, z), and the posture information is represented by angles (yaw, pitch, roll). In various control systems of the HMD 101, the position and the posture indicated by the position-and-posture information are converted into a position and a posture relative to the current position of the user 102 with reference to a position and a posture at an arbitrary point in the real space, and then used. In the following description, position-and-posture information about the user 102 is denoted as “position information” when attention is focused on position information, and is denoted as “posture information” when attention is focused on posture information.

The description returns to FIG. 3. The position presentation module 306 presents the position indicated by the position information recorded in the position-posture-and-image information 305 and the current position of the user 102 with marks or a list. The position presentation module 306 present only one position if positions are overlapped. A position designation module 307 designates one position from among the positions presented by the position presentation module 306 in accordance with an instruction from the user 102. The user 102 issues an instruction using the operation device 209 (for example, a controller) in the HMD 101, a gesture, or a voice.

An image generation module 308 generates a pseudo image by resembling a visual field of the user 102 at the position designated by the position designation module 307. The pseudo image is an image of a pseudo real space in assuming that the user 102 wearing the HMD 101 views the real space at the position designated by the position designation module 307. The image generation module 308 generates, as a pseudo image, a real image recorded in association with the position information indicating the position designated by the position designation module 307 in the position-posture-and-image information 305. However, the image generation module 308 generates, when different pieces of the posture information are associated with the position information indicating the position designated by the position designation module 307, a pseudo image using an image set by the user 102 or an image corresponding to a median value of the different pieces of the posture information. Thereafter, an arrow to guide the user 102 to a posture indicated by the posture information associated with the real image used to generate the pseudo image is displayed on the display device 208 of the HMD 101 that is displaying the pseudo image.

A first display module 309 displays the real image obtained by the real image obtaining module 301, that is, the real image at the current position and the posture of the user 102 on the display device 208 of the HMD 101. A second display module 310 displays the pseudo image generated by the image generation module 308 on the display device 208 of the HMD 101. A switching module 311 switches a display content in accordance with the position designated by the position designation module 307. When the position designated by the position designation module 307 is the current position of the user 102, the switching module 311 switches the display content to the real image. On the other hand, when the position designated by the position designation module 307 is not the current position of the user 102, that is, when the position is indicated by the position information recorded in the position-posture-and-image information 305, the switching module 311 switches the display content to the pseudo image.

In a case where the pseudo image is displayed on the display device 208 of the HMD 101, the user 102 wearing the HMD 101 is difficult to walk. Therefore, when the current position of the user 102 is changed, the CPU 201 (a first change unit) of the HMD 101 controls the switching module 311 to switch the display content from the pseudo image to the real image. The presentation of the position by the position presentation module 306 and the designation of the position by the position designation module 307 are also performed in displaying the real image by the first display module 309 and in displaying the pseudo image by the second display module 310.

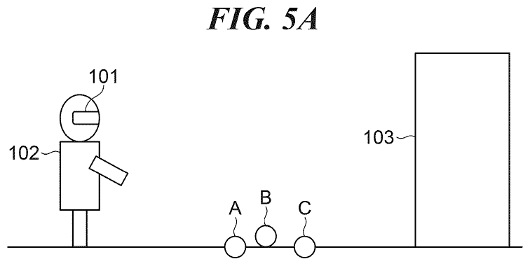

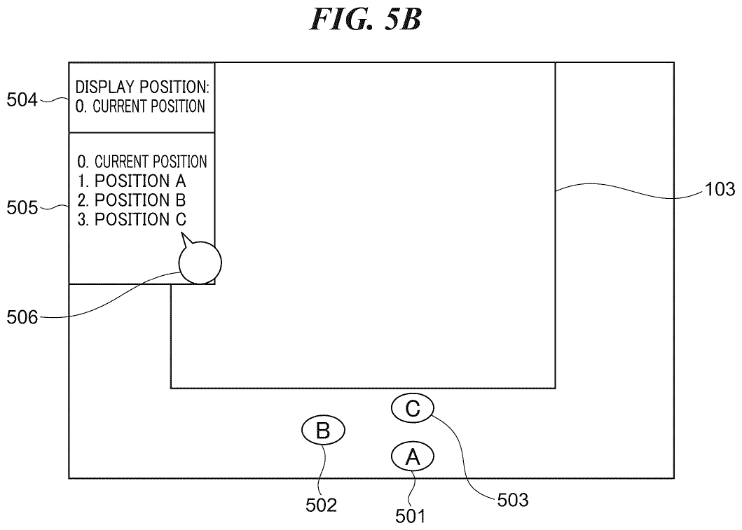

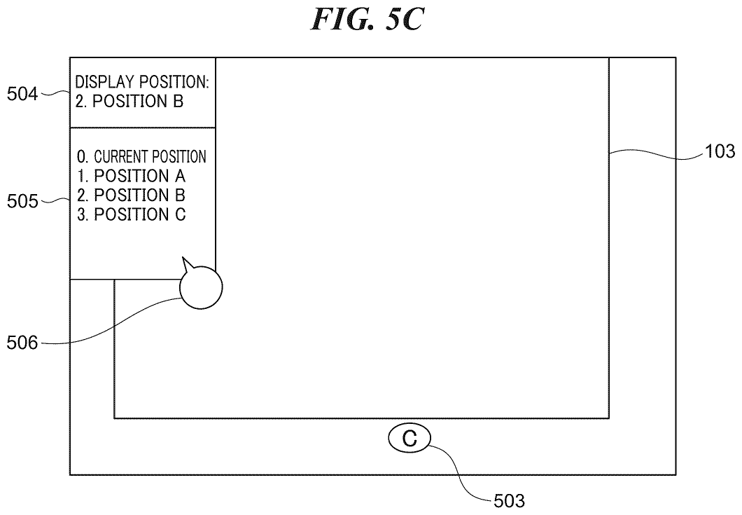

FIG. 5A, FIG. 5B, and FIG. 5C are views illustrating examples when the display content is switched. FIG. 5A is a view illustrating an example of a scene in which the user 102 switches the display content on the display device 208 of the HMD 101 worn on the head to the real image or the pseudo image. A position A, a position B, and a position C indicate positions indicated by the respective pieces of position information recorded in the position-posture-and-image information 305. In the following description, the position A, the position B, and the position C are the names of the respective positions.

FIG. 5B is a view illustrating an example of a screen when a real image at the current position of the user 102 is displayed on the display device 208 of the HMD 101. The position presentation module 306 displays marks 501, 502, and 503 on the screen. The mark 501 indicates the position A, the mark 502 indicates the position B, and the mark 503 indicates the position C. A window 504 shows the position of the user 102 whose visual field is displayed on the display device 208 of the HMD 101. Hereinafter, the position of the user 102 whose visual field is displayed on the display device 208 of the HMD 101 is referred to as a “display position”. In the window 504 in FIG. 5B, “DISPLAY POSITION: 0. CURRENT POSITION” is displayed. The window 504 is displayed by the position presentation module 306.

In a list 505 displayed by the position presentation module 306, numbers and the position names are displayed in association with each other. The list 505 is a three dimensional UI that can be interacted, but may be a two dimensional UI. The same applies to the marks 501, 502, and 503. A hand icon 506 is displayed at a position of the hand of the user 102 detected by a hand tracking function of the HMD 101. When the user 102 presses, for example, “2. POSITION B” in the list 505 or the mark 502 with the hand icon 506 by a gesture, the screen in FIG. 5B transitions to a screen in FIG. 5C.

FIG. 5C is a view illustrating an example of a screen when the pseudo image at the position B is displayed on the display device 208 of the HMD 101. In this case, the mark 503 is displayed on the screen in FIG. 5C. In addition, “DISPLAY POSITION: 2. POSITION B” is displayed in the window 504. When the user 102 presses, for example, “3. POSITION B” in the list 505 or the mark 503 with the hand icon 506 by a gesture, the pseudo image at the position C is displayed on the display device 208 of the HMD 101.

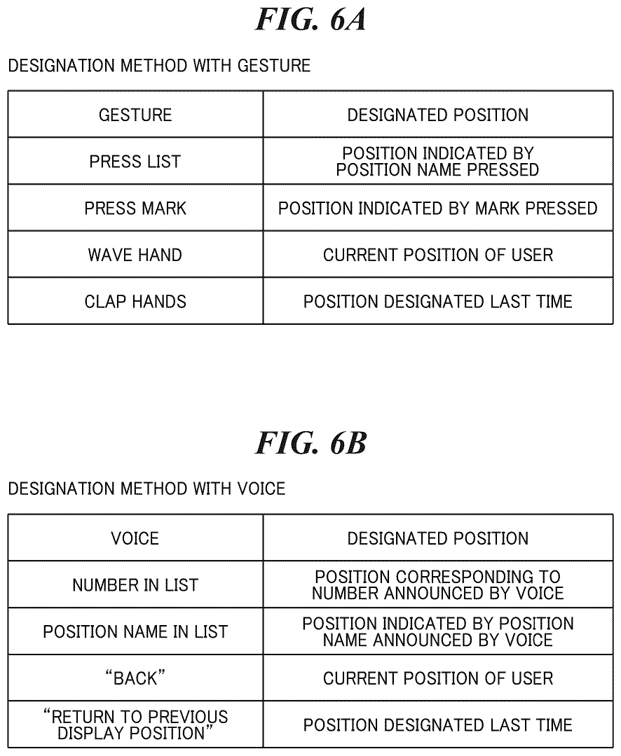

FIG. 6A and FIG. 6B are views illustrating examples of methods of designating a position with the position designation module 307. The methods of designating the position with the position designation module 307 include designation by the operation device 209 (for example, a controller) of the HMD 101, designation by a gesture, designation by a voice, etc. Among them, FIG. 6A indicates the designation by gestures, and FIG. 6B indicates the designation by voices. In the case of the designation by gestures, the position designation module 307 designates one position from among the positions presented by the position presentation module 306 by recognizing a gesture of the user 102 by the hand tracking function of the HMD 101. When the hand icon 506 presses any number or position name on the list 505 by an operation of the hand of the user 102, the position indicated by the pressed number or position name is designated. When the hand icon 506 presses any of the marks 501, 502, and 503 by an operation of the hand of the user 102, the position indicated by the pressed mark is designated. When the user 102 waves the hand, the current position of the user 102 is designated. When the user 102 claps the hands (a predetermined gesture), the position designated previous time is designated.

In the case of the designation by voices, the position designation module 307 designates one position from among the positions presented by the position presentation module 306 by recognizing a voice of the user 102 by the voice recognizing function of the HMD 101. When the user 102 speaks a number in the list 505, the position indicated by the number is designated. When the user 102 utters a position name in the list 505, the position indicated by the position name is designated. When the user 102 says “back”, the current position of the user 102 is designated. When the user 102 says “return to previous display position” (a predetermined voice), the position designated previous time is designated. When the designated position is the current position of the user 102, the real image at the current position of the user 102 is displayed on the display device 208 of the HMD 101. In addition, when the designated position is not the current position of the user 102, that is, when the designated position is a position indicated by the position information recorded in the position-posture-and-image information 305, a pseudo image at the designated position is displayed on the display device 208 of the HMD 101.

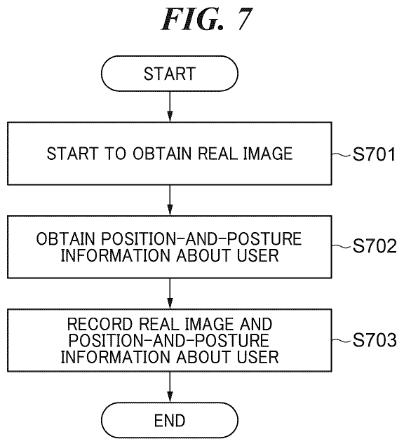

FIG. 7 is a flowchart illustrating a process of recording the position-and-posture information and the real image in the position-posture-and-image information 305 of the HMD101. The process in the flowchart in FIG. 7 is achieved by the CPU 201 reading a program recorded in the storage device 206, expanding it onto the RAM 203, and executing it. When the process of the flowchart in FIG. 7 is started, the CPU 201 starts to obtain a real image with the real image obtaining module 301 in a step S701. The CPU 201 (a guidance display unit) displays a guidance of an image capturing position and an image capturing range on the display device 208 of the HMD 101 with the recording-position-guidance display module 303. Further, the CPU 201 (a first guiding unit) displays the arrow 105 (first information) on the display device 208 of the HMD 101 with the recording-position-guidance display module 303. In a step S702, the CPU 201 (information obtaining unit) gets the current position-and-posture information about the user 102 with the user position-and-posture obtaining module 302.

In a step S703, the CPU 201 obtains the real image at the position and posture indicated by the position-and-posture information obtained in the step S702 from among the real images obtained with the real image obtaining module 301. Further, the CPU 201 (an association recording unit) records, with the recording module 304, the real image obtained in this manner in the position-posture-and-image information 305 in association with the position-and-posture information obtained in the step S702. As described above, the recording module 304 records the data in the step S703 in response to an instruction to start recording by the user 102 or when the current position of the user 102 keeps the same position during a certain time period. After that, the process in the flowchart in FIG. 7 ends.

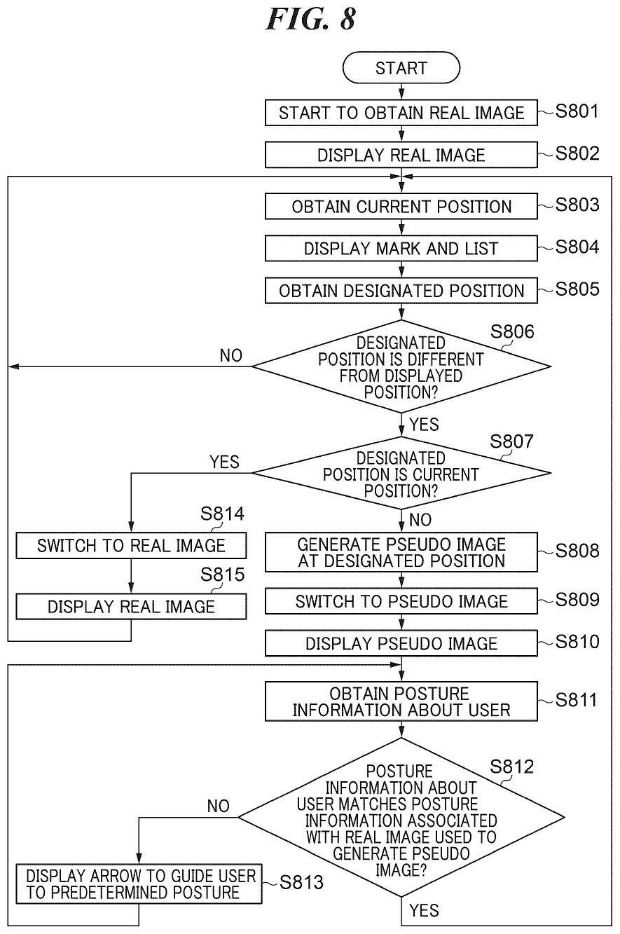

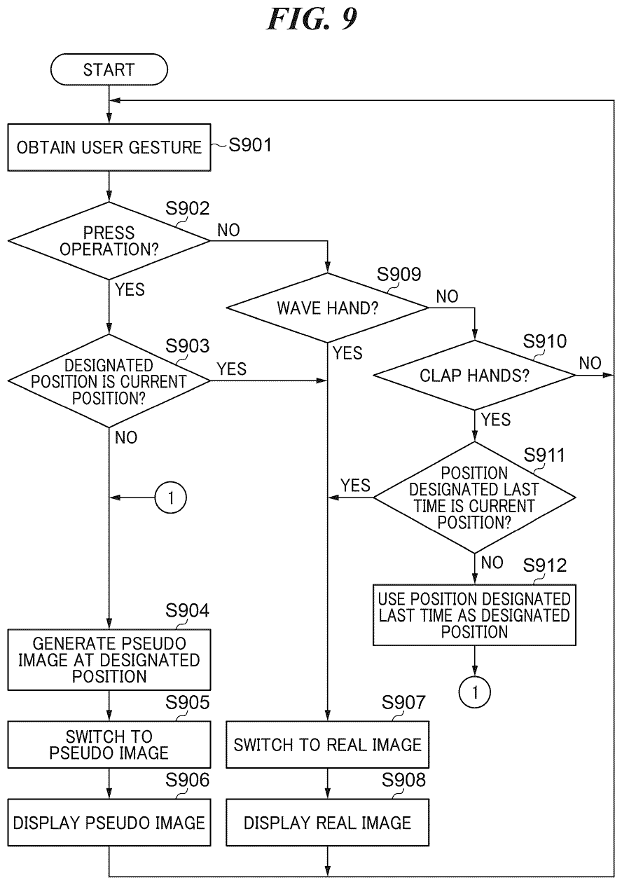

FIG. 8 is a flowchart illustrating a process when the display content is switched between the real image and the pseudo image in the HMD 101. The process (a control method of the information processing apparatus) shown in the flowchart in FIG. 8 is achieved by the CPU 201 (a computer) developing a program stored in the storage device 206 onto the RAM 203 and executing the information processing program. This point is the same for a flowchart in FIG. 9 described later. When the process of the flowchart in FIG. 8 is started, the CPU 201 starts to obtain a real image with the real image obtaining module 301 in a step S801. In a step S802, the CPU 201 displays the real image obtained with the real image obtaining module 301 on the display device 208 of the HMD 101 with the first display module 309. Accordingly, the real image at the current position of the user 102 is displayed on the display device 208 of the HMD 101. In a step S803, the CPU 201 (a position obtaining unit) obtains the current position of the user 102 from the position-and-posture information obtained with the user position-and-posture obtaining module 302 (a position obtaining step).

In a step S804, the CPU 201 (a presentation unit) displays the marks 501, 502, and 503, the list 505, etc. with the position presentation module 306 (a presentation step). Accordingly, the position presentation module 306 presents the position indicated by the position information recorded in the position-posture-and-image information 305 and the current position of the user 102 as the marks 501, 502, and 503, and the list 505. When a plurality of pieces of position information indicating the same position are recorded in the position-posture-and-image information 305, the position presentation module 306 presents only one position. In a step S805, the CPU 201 (a designation unit) designates a position with the position designation module 307 in accordance with an instruction from the user 102 using the operation device 209 (for example, a controller) of the HMD 101, a gesture, or a voice (a designation step). In this way, the position designation module 307 obtains a position designated by the user 102 (hereinafter, referred to as a “designated position”) from among the positions presented with the position presentation module 306.

In a step S806, the CPU 201 determines whether the designated position is different from the displayed position with the position designation module 307. When the CPU 201 determines with the position designation module 307 that the designated position is different from the displayed position, the process proceeds to a step S807. On the other hand, when the CPU 201 determines with the position designation module 307 that the designated position is not different from the displayed position, the process returns to the step S803. Thus, the determination process in the step S806 is repeated until the designated position becomes different from the display position. In a step S807, the CPU 201 determines with the position designation module 307 whether the specified location is the current position of the user 102. When the CPU 201 determines with the position designation module 307 that the designated position is the current position of the user 102, the process proceeds to a step S814 described below. On the other hand, when the CPU 201 determines with the position designation module 307 that the designated position is not the current position of the user 102, the process proceeds to a step S808. That is, when the position designated by the user 102 is the position indicated by the position information recorded in the position-posture-and-image information 305, the process proceeds to the step S808.

In the step S808, the CPU 201 (a generation unit) generates a pseudo image with the image generation module 308 (a generation step). At this time, the image generation module 308 generates a pseudo image using the real image recorded in association with the position information indicating the designated position obtained in the step S805 in the position-posture-and-image information 305. In a step S809, the CPU 201 switches with the switching module 311 the display content from the real image at the current position of the user 102 to the pseudo image generated in the step S808. In a step S810, the CPU 201 (a second display control unit) displays the pseudo image switched in the step S809 on the display device 208 of the HMD 101 with the second display module 310 (a second display control step). Accordingly, the pseudo image at the designated position obtained in the step S805 is displayed on the display device 208 of the HMD 101.

In a step S811, the CPU 201 obtains the current posture information about the user 102 with the user position-and-posture obtaining module 302. In a step S812, the CPU 201 determines whether the posture information obtained in the step S811 matches the posture information associated with the real image used when the pseudo image is generated with the image generation module 308 in the step S808. When the CPU 201 determines that the posture information obtained in the step S811 matches the posture information associated with the real image used when the pseudo image is generated with the image generation module 308 in the step S808, the process returns to the step S803.

On the other hand, when the CPU 201 determines that the posture information obtained in the step S811 does not match the posture information associated with the real image used when the pseudo image is generated with the image generation module 308 in the step S808, the process proceeds to a step S813. In the step S813, the CPU 201 (a second guiding unit) displays an arrow (second information) on the display device 208 of the HMD 101 with the image generation module 308. The arrow in this case is displayed to guide the user 102 to a predetermined posture indicated by the posture information associated with the real image used when the pseudo image is generated with the image generation module 308. Thereafter, the process returns to the step S811. As described above, when the current position of the user 102 is changed in a state where the pseudo image is displayed on the display device 208 of the HMD 101, the CPU 201 switches the display content from the pseudo image to the real image with the switching module 311.

In the step S814, the CPU 201 switches with the switching module 311 the display content from the pseudo image to the real image that is being obtained with the real image obtaining module 301. In a step S815, the CPU 201 (a first display control unit) displays with the first display module 309 the real image switched in the step S814 on the display device 208 of the HMD 101 (a first display control step). Accordingly, the real image at the current position of the user 102 is displayed on the display device 208 of the HMD 101. Thereafter, the process returns to the step S803.

FIG. 9 is a flowchart illustrating a process when the display content is switched between the real image and the pseudo image in the HMD 101, and is the flowchart specialized for a process when the position is designated by a gesture of the user 102. When the process in the flowchart in FIG. 9 is started, the CPU 201 obtain a gesture of the user 102 with the position designation module 307 in a step S901. In a step S902, the CPU 201 determines with the position designation module 307 whether the gesture of the user 102 is a press operation. When the CPU 201 determines with the position designation module 307 that the gesture of the user 102 is the press operation, the process proceeds to a step S903. On the other hand, when the CPU 201 determines with the position designation module 307 that the gesture of the user 102 is not a press operation, the process proceeds to a step S909 described later.

In the step S903, the CPU 201 determines with the position designation module 307 whether the position designated by the press operation of the gesture of the user 102 (hereinafter referred to as a “designated position”) is the current position of the user 102. When the CPU 201 determines with the position designation module 307 that the designated position is the current position of the user 102, the process proceeds to a step S907 described below. On the other hand, when the CPU 201 determines with the position designation module 307 that the designated position is not the current position of the user 102, the process proceeds to a step S904. That is, when the designated position is the position indicated by the position information recorded in the position-posture-and-image information 305, the process proceeds to the step S904.

Since the steps S904 to S906 are the same as the steps S808 to S810 in FIG. 8, their detailed descriptions will be omitted. Thereafter, the process returns to the step S901. Further, since the steps S907 and S908 are the same as the steps S814 and S815 in FIG. 8, their detailed descriptions will be omitted. Thereafter, the process returns to the step S901. In the step S909, the CPU 201 determines with the position designation module 307 whether the gesture of the user 102 is an operation to wave a hand. When the CPU 201 determines with the position designation module 307 that the gesture of the user 102 is the operation to wave a hand, the process proceeds to a step S907 described above. On the other hand, when the CPU 201 determines with the position designation module 307 that the gesture of the user 102 is not the operation to wave a hand, the process proceeds to a step S910.

In the step S910, the CPU 201 determines with the position designation module 307 whether the gesture of the user 102 is an operation to clap hands. When the CPU 201 determines with the position designation module 307 that the gesture of the user 102 is the operation to clap hands, the process proceeds to a step S911. On the other hand, when the CPU 201 determines with the position designation module 307 that the gesture of the user 102 is not the operation to clap hands, the process returns to the step S901. In the step S911, the CPU 201 determines with the position designation module 307 whether the position designated last time is the current position of the user 102. When the CPU 201 determines with the position designation module 307 that the position designated last time is the current position of the user 102, the process proceeds to the step S907 described above. Accordingly, the real image at the current position of the user 102 is displayed on the display device 208 of the HMD 101.

On the other hand, when the CPU 201 determines with the position designation module 307 that the position designated last time is not the current position of the user 102, the process proceeds to a step S912. That is, when the position designated last time is the position indicated by the position information recorded in the position-posture-and-image information 305, the process proceeds to the step S912. In the step S912, the CPU 201 sets with the position designation module 307 the position designated last time as the designated position. Thereafter, the process proceeds to the step S904 described above. Accordingly, the pseudo image at the position designated last time is displayed on the display device 208 of the HMD 101. When the position is designated by a voice of the user 102, the display content is switched between the real image and the pseudo image in the same manner as in the flowchart in FIG. 9. The above is the description of the first embodiment.

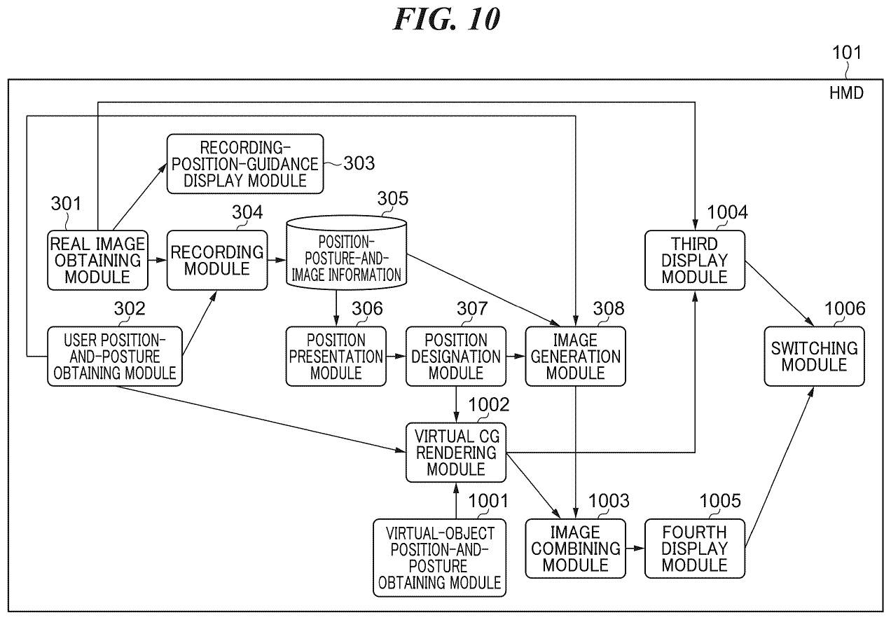

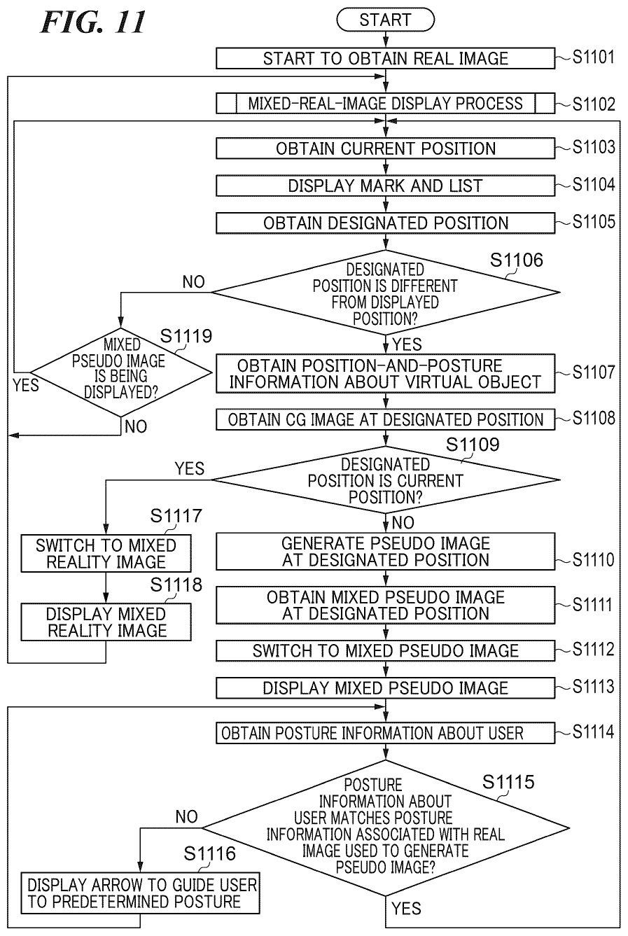

Hereinafter, a second embodiment will be described with reference to FIG. 10 and FIG. 11. In the second embodiment, differences from the first embodiment will be described. In the HMD 101 in the first embodiment, the real image at the current position of the user 102 and the pseudo image at the position designated by the user 102 are switched and displayed. However, when the user 102 wearing the HMD 101 is experiencing mixed reality, the user 102 sees a virtual object in a virtual space of the mixed reality. Therefore, an example in which a virtual object is displayed in a real image at the current position of user 102 or a pseudo image at a position designated by the user 102 will be described in the second embodiment.

FIG. 10 is a block diagram illustrating a functional configuration of the HMD 101 in the second embodiment. A virtual-object position-and-posture obtaining module 1001 obtains position-and-posture information about a virtual object in the virtual space of the mixed reality in three dimensions. A virtual CG rendering module 1002 obtains a CG image by rendering virtual CG using the posture information about the user 102 at the position designated by the position designation module 307 and position-and-posture information about the virtual object.

An image combining module 1003 combines the pseudo image generated by the image generation module 308 and the CG image generated by the virtual CG rendering module 1002. In this way, the image combining module 1003 obtains a composite image (hereinafter referred to as a “mixed pseudo image”) by combining the pseudo image at the position designated by the position designation module 307 and the CG image. A third display module 1004 displays the mixed reality image at the current position and posture of the user 102 on the display device 208 of the HMD 101 using the real image obtained by the real image obtaining module 301 and the CG image obtained by the virtual CG rendering module 1002. A fourth display module 1005 displays the mixed pseudo image obtained by the image combining unit 1003 on the display device 208 of the HMD 101. That is, the fourth display unit 1005 displays the mixed pseudo image assumed to be viewed at the position designated by the position designation module 307 on the display device 208 of the HMD 101.

A switching module 1006 switches a display content to an image at the position designated by the position designation module 307. When the position designated by the position designation module 307 is the current position of the user 102, the switching module 1006 switches the display content to the mixed reality image. When the position designated by the position designation module 307 is not the current position of the user 102, that is, when the position is indicated by the position information recorded in the position-posture-and-image information 305, the switching module 1006 switches the display content to a mixed pseudo image. When the mixed pseudo image is displayed on the display device 208 of the HMD 101, it is difficult for the user 102 wearing the HMD 101 to walk. Therefore, when the current position of the user 102 is changed, the CPU 201 (a second changing unit) of the HMD 101 switches the display content for the mixed pseudo image to the mixed reality image with the switching module 1006. The presentation of the position by the position presentation module 306 and the designation of the position by the position designation module 307 are also performed in the mixed reality image displayed by the third display module 1004 and the mixed pseudo image displayed by the fourth display module 1005.

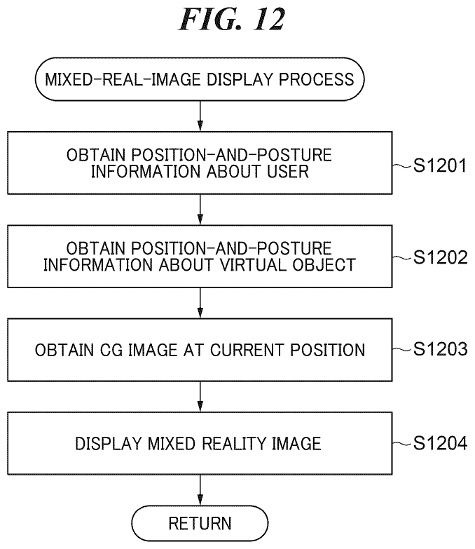

FIG. 11 is a flowchart illustrating a process to switch a displayed content between a mixed reality image and a mixed pseudo image in the HMD 101. The process in the flowchart in FIG. 11 (a control method for the information processing apparatus) is achieved by the CPU 201 (a computer) reading a program recorded in the storage device 206, developing it onto the RAM 203, and executing it. When the process of the flowchart in FIG. 11 is started, the CPU 201 starts to obtain a real image with the real image obtaining module 301 in a step S1101. In a step S1102, the CPU 201 performs a mixed-real-image display process. FIG. 12 is a flowchart illustrating the mixed-real-image display process in the step S1102. When the process in the flowchart in FIG. 12 is started, the CPU 201 obtains current position-and-posture information about the user 102 with the user position-and-posture obtaining module 302 in a step S1201.

In a step S1202, the CPU 201 obtains position-and-posture information about the virtual object three dimensionally with the virtual-object position-and-posture obtaining module 1001. In a step S1203, the CPU 201 obtains a CG image at the current position of the user 102 with the virtual CG rendering module 1002. In a step S1204, the CPU 201 displays the mixed reality image at the current position and posture of the user 102 on the display device 208 of the HMD 101 with the third display module 1004. At this time, the third display module 1004 uses the real image obtained by the real image obtaining module 301 and the CG image obtained in the step S1203. As a result, the mixed reality image at the current position of the user 102 is displayed on the display device 208 of the HMD 101. Thereafter, the process returns to the flowchart in FIG. 11, and the process proceeds to a step S1103.

The description returns to FIG. 11. Since the steps S1103 to S1105 are the same as the steps S803 to S805 in FIG. 8, their detailed descriptions will be omitted. In a step S1106, the CPU 201 determines whether the designated position is different from the display position with the position designation module 307. When the CPU 201 determines with the position designation module 307 that the designated position is different from the display position, the process proceeds to a step S1107. On the other hand, when the CPU 201 determines with the position designation module 307 that the designated position is not different from the display position, the process proceeds to a step S1119 described later. In the step S1107, the CPU 201 obtains the position-and-posture information about the virtual object three dimensionally with the virtual-object position-and-posture obtaining module 1001. In a step S1108, the CPU 201 (a rendering unit) obtains the CG image at the designated position obtained in the step S1105 with the CG rendering module 1002 (a rendering step).

In a step S1109, the CPU 201 determines with the position designation module 307 whether the designated position is the current position of the user 102. When the CPU 201 determines with the position designation module 307 that the designated position is the current position of the user 102, the process proceeds to a step S1117 described below. On the other hand, when the CPU 201 determines with the position designation module 307 that the designated position is not the current position of the user 102, the process proceeds to a step S1110. That is, when the position designated by the user 102 is the position indicated by the position information recorded in the position-posture-and-image information 305, the process proceeds to the step S1110.

In the step S1110, the CPU 201 (a generation unit) generates the pseudo image with the image generation module 308 (a generation step). At this time, the image generation module 308 generates a pseudo image using the real image recorded in association with the position information indicating the designated position obtained in the step S1105 in the position-posture-and-image information 305. In a step S1111, the CPU 201 (a combining unit) combines the pseudo image obtained in the step S1110 and the CG image obtained in the step S1108 with the image combining unit 1003 (a combining step). Accordingly, the image combining unit 1003 obtains a mixed pseudo image at the designated position obtained in the step S1105.

In a step S1112, the CPU 201 switches the display content from the mixed reality image at the current position of the user 102 to the mixed pseudo image obtained in the step S1111 with the switching module 1006. In a step S1113, the CPU 201 (a fourth display control unit) displays the mixed pseudo image switched in the step S1112 on the display device 208 of the HMD 101 with the fourth display module 1005 (a fourth display control step). Accordingly, the mixed pseudo image at the designated position obtained in the step S1105 is displayed on the display device 208 of the HMD 101.

Since the steps S1114 to S1116 are the same as the steps S811 to S813 in FIG. 8, their detailed descriptions will be omitted. In a step S1117, the CPU 201 switches the display content from the mixed pseudo image to the mixed reality image with the switching module 1006. In a step S1118, the CPU 201 (a third display control unit) displays the mixed reality image on the display device 208 of the HMD 101 with the third display module 1004 (a third display control step). At this time, the third display module 1004 uses the real image obtained with the real image obtaining module 301 and the CG image obtained at the step S1108. As a result, the mixed reality image at the current position of the user 102 is displayed on the display device 208 of the HMD 101. Thereafter, the process returns to the step S1102.

In a step S1119, the CPU 201 determines with the fourth display module 1005 whether the mixed pseudo image is being displayed. When the CPU 201 determines with the fourth display module 1005 that the mixed pseudo image is being displayed, the process returns to the step S1103. That is, when the mixed pseudo image is being displayed on the display device 208 of the HMD101, the process returns to the step S1103. On the other hand, when the CPU 201 determines with the fourth display module 1005 that the mixed pseudo image is not being displayed, the process returns to the S1102. That is, when the mixed reality image is being displayed on the display device 208 of the HMD 101, the process returns to the step S1102. The above is the description of the second embodiment.

As described above, the HMD 101 in the first embodiment allows the user 102 to switch and display the real image at the current position and the pseudo image at the designated position by designating one position from among the presented positions without moving on foot. Similarly, the HMD 101 in the second embodiment allows the user 102 to switch and display the mixed reality image at the current position and the mixed pseudo image at the designated position by designating one position from among the presented positions without moving on foot. Therefore, the HMDs 101 in the first and second embodiments can easily switch and display the image viewed by the user 102 at the current position and the pseudo image assumed to be viewed by the user 102 at the designated position.

Although the preferred embodiments of the present disclosure have been described above, the present disclosure is not limited to the above-described embodiments, and various modifications and changes can be made within the scope of the gist thereof. For example, the position designation module 307 may designate one position from among the positions presented by the position presentation module 306 by using a ray extending from a controller held by the user 102 or a ray extending from a hand of the user 102. Further, the position designation module 307 may designate one position from among the positions presented by the position presentation module 306 by analyzing a line of sight of the user 102 using an eye tracking function of the HMD 101. In addition, when the user 102 designates the position designated last time in response to an action of the user 102 clapping the hands or uttering “return to last display position”, the position designation module 307 may exclude the current position of the user from the previously designated positions. In addition, in the position-posture-and-image information 305, the real image associated with the position-and-posture information about the user 102 is a still image compressed in the JPEG format by the data compression, but may be a moving image of the same angle.

According to the present disclosure, it is possible to easily switch and display an image viewed by a user at a current position and a pseudo image assumed to be viewed by the user at a designated position.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The disclosure of the embodiments includes the following configurations, methods, and media.

(Configuration 1) An information processing apparatus comprising:
a memory device that stores a set of instructions; and at least one processor that executes the set of instructions to:
obtain a current position of a user;
present a plurality of positions including the current position with a display device;
designate a position from among the plurality of positions in accordance with an instruction from a user;
display an image obtained by an image capturing device capturing a real space as a real image indicating a visual field of the user at the current position on the display device in a case where the position designated is the current position; and
display a pseudo image generated by resembling a visual field of the user at the position designated on the display device in a case where the position designated is not the current position.

(Configuration 2) The information processing apparatus according to configuration 1, wherein the at least one processor executes instructions in the memory device to change a display content on the display device from the pseudo image to the real image in a case where the current position is changed while the pseudo image is displayed on the display device.

(Configuration 3) An information processing apparatus comprising:
a memory device that stores a set of instructions; and
at least one processor that executes the set of instructions to:
obtain a current position of a user;
present a plurality of positions including the current position with a display device;
designate a position from among the plurality of positions in accordance with an instruction from a user;
render a computer graphic image in which a virtual object coming in a visual field of the user at the position designated is represented;
display a mixed reality image as a real image indicating the visual field of the user at the current position using an image obtained by an image capturing device capturing a real space and the computer graphic image on the display device in a case where the position designated is the current position; and
display a mixed pseudo image obtained by combining a pseudo image generated by resembling a visual field of the user at the position designated and the computer graphic image on the display device in a case where the position designated is not the current position.

(Configuration 4) The information processing apparatus according to configuration 3, wherein the at least one processor executes instructions in the memory device to change a display content on the display device from the mixed pseudo image to the mixed reality image in a case where the current position is changed while the mixed pseudo image is displayed on the display device.

(Configuration 5) The information processing apparatus according to configuration 1 or 3, wherein the at least one processor executes instructions in the memory device to present the plurality of positions on the display device by displaying marks at locations of the plurality of positions in an image being displayed on the display device.

(Configuration 6) The information processing apparatus according to configuration 1 or 3, wherein the at least one processor executes instructions in the memory device to present the plurality of positions by displaying a list of position names of the plurality of positions on the display device.

(Configuration 7) The information processing apparatus according to configuration 1 or 3, wherein the at least one processor executes instructions in the memory device to designate a position from among the plurality of positions in accordance with an instruction issued by an operation of a controller by the user.

(Configuration 8) The information processing apparatus according to configuration 1 or 3, wherein the at least one processor executes instructions in the memory device to designate a position from among the plurality of positions in accordance with an instruction issued by a gesture of the user.

(Configuration 9) The information processing apparatus according to configuration 8, wherein the at least one processor executes instructions in the memory device to designate a position designated previous time among the plurality of positions when the gesture by the user is a predetermined gesture.

(Configuration 10) The information processing apparatus according to configuration 1 or 3, wherein the at least one processor executes instructions in the memory device to designate a position from among the plurality of positions in accordance with an instruction issued by voice of the user.

(Configuration 11) The information processing apparatus according to configuration 10, wherein the at least one processor executes instructions in the memory device to designate a position designated previous time among the plurality of positions when the voice of the user is a predetermined voice.

(Configuration 12) The information processing apparatus according to configuration 1 or 3, wherein the at least one processor executes instructions in the memory device to designate a position from among the plurality of positions in accordance with an instruction issued with a ray extending from a hand of the user or a ray extending from a controller.

(Configuration 13) The information processing apparatus according to configuration 1 or 3, wherein the at least one processor executes instructions in the memory device to designates a position from among the plurality of positions in accordance with an instruction issued by a line of sight of the user.

(Configuration 14) The information processing apparatus according to configuration 1 or 3, wherein the at least one processor executes instructions in the memory device to:
obtain position information and posture information indicating a position and a posture of the user;
record the position information and the posture information obtained in association with the real image when the real image is obtained; and
generate the pseudo image using the real image recorded in association with the position information indicating the position designated.

(Configuration 15) The information processing apparatus according to configuration 14, wherein the at least one processor executes instructions in the memory device to generate, when different pieces of the posture information are associated with the position information indicating the position designated, the pseudo image using an image set by the user or an image corresponding to a median value of the different pieces of the posture information.

(Configuration 16) The information processing apparatus according to configuration 14, wherein the at least one processor executes instructions in the memory device to record the position information and the posture information in association with the real image when the current position keeps a same position during a certain time period.

(Configuration 17) The information processing apparatus according to configuration 14, wherein there are a plurality of data combinations each in which the position information and the posture information are association with the real image.

(Configuration 18) The information processing apparatus according to configuration 14, wherein the at least one processor executes instructions in the memory device to display, on the display device, a guidance indicating an image capturing range or an image capturing position in obtaining the real image, which is recorded, by the image capturing device.

(Configuration 19) The information processing apparatus according to configuration 14, wherein the at least one processor executes instructions in the memory device to display, on the display device, first information for guiding the user to a posture in obtaining the real image, which is recorded, by the image capturing device.

(Configuration 20) The information processing apparatus according to configuration 14, wherein the at least one processor executes instructions in the memory device to display, on the display device, second information for guiding the user to a posture indicated by the posture information recorded in association with the real image.

(Configuration 21) The information processing apparatus according to configuration 1 or 3, wherein the information processing apparatus is a head mounted display including the image capturing device and the display device.

(System 1) An information processing system comprising:
an image capturing device;
a display device; and
an information processing apparatus comprising:
a memory device that stores a set of instructions; and
at least one processor that executes the set of instructions to:
obtain a current position of a user;
present a plurality of positions including the current position with a display device;
designate a position from among the plurality of positions in accordance with an instruction from a user;
display an image obtained by an image capturing device capturing a real space as a real image indicating a visual field of the user at the current position on the display device in a case where the position designated is the current position; and
display a pseudo image generated by resembling a visual field of the user at the position designated on the display device in a case where the position designated is not the current position.

(System 2) The information processing system according to system 1, wherein the image capturing device is a camera held by the user.

(System 3) The information processing system according to system 1, wherein the image capturing device is a 360-degree camera.

(Method 1) A control method for an information processing apparatus, the control method comprising:
obtaining a current position of a user;
presenting a plurality of positions including the current position with a display device;
designating a position from among the plurality of positions in accordance with an instruction from a user;
displaying an image obtained by an image capturing device capturing a real space as a real image indicating a visual field of the user at the current position on the display device in a case where the position designated is the current position; and
displaying a pseudo image generated by resembling a visual field of the user at the position designated on the display device in a case where the position designated is not the current position.

(Method 2) A control method for an information processing apparatus, the control method comprising:
obtaining a current position of a user;
presenting a plurality of positions including the current position with a display device;
designating a position from among the plurality of positions in accordance with an instruction from a user;
rendering a computer graphic image in which a virtual object coming in a visual field of the user at the position designated is represented;
displaying a mixed reality image as a real image indicating the visual field of the user at the current position using an image obtained by an image capturing device capturing a real space and the computer graphic image on the display device in a case where the position designated is the current position; and
displaying a mixed pseudo image obtained by combining a pseudo image generated by resembling a visual field of the user at the position designated and the computer graphic image on the display device in a case where the position designated is not the current position.

(Medium 1) A non-transitory computer-readable storage medium storing a control program causing a computer to execute a control method for an information processing apparatus, the control method comprising:
obtaining a current position of a user;
presenting a plurality of positions including the current position with a display device;
designating a position from among the plurality of positions in accordance with an instruction from a user;
displaying an image obtained by an image capturing device capturing a real space as a real image indicating a visual field of the user at the current position on the display device in a case where the position designated is the current position; and
displaying a pseudo image generated by resembling a visual field of the user at the position designated on the display device in a case where the position designated is not the current position.

(Medium 2) A non-transitory computer-readable storage medium storing a control program causing a computer to execute a control method for an information processing apparatus, the control method comprising:
obtaining a current position of a user;
presenting a plurality of positions including the current position with a display device;
designating a position from among the plurality of positions in accordance with an instruction from a user;
rendering a computer graphic image in which a virtual object coming in a visual field of the user at the position designated is represented;
displaying a mixed reality image as a real image indicating the visual field of the user at the current position using an image obtained by an image capturing device capturing a real space and the computer graphic image on the display device in a case where the position designated is the current position; and
displaying a mixed pseudo image obtained by combining a pseudo image generated by resembling a visual field of the user at the position designated and the computer graphic image on the display device in a case where the position designated is not the current position.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
a memory device that stores a set of instructions; and
at least one processor that executes the set of instructions to:
obtain a current position of a user;
present a plurality of positions including the current position with a display device;
designate a position from among the plurality of positions in accordance with an instruction from a user;
display an image obtained by an image capturing device capturing a real space as a real image indicating a visual field of the user at the current position on the display device in a case where the position designated is the current position; and
display a pseudo image generated by resembling a visual field of the user at the position designated on the display device in a case where the position designated is not the current position.

2. The information processing apparatus according to claim 1, wherein the at least one processor executes instructions in the memory device to change a display content on the display device from the pseudo image to the real image in a case where the current position is changed while the pseudo image is displayed on the display device.

3. The information processing apparatus according to claim 1, wherein the at least one processor executes instructions in the memory device to:
render a computer graphic image in which a virtual object coming in a visual field of the user at the position designated is represented;
display a mixed reality image as a real image indicating the visual field of the user at the current position using an image obtained by an image capturing device capturing a real space and the computer graphic image on the display device in a case where the position designated is the current position; and
display a mixed pseudo image obtained by combining the pseudo image and the computer graphic image on the display device in a case where the position designated is not the current position.

4. The information processing apparatus according to claim 3, wherein the at least one processor executes instructions in the memory device to change a display content on the display device from the mixed pseudo image to the mixed reality image in a case where the current position is changed while the mixed pseudo image is displayed on the display device.

5. The information processing apparatus according to claim 1, wherein the at least one processor executes instructions in the memory device to present the plurality of positions on the display device by displaying marks at locations of the plurality of positions in an image being displayed on the display device.

6. The information processing apparatus according to claim 1, wherein the at least one processor executes instructions in the memory device to present the plurality of positions by displaying a list of position names of the plurality of positions on the display device.

7. The information processing apparatus according to claim 1, wherein the at least one processor executes instructions in the memory device to designate a position from among the plurality of positions in accordance with an instruction issued by an operation of a controller by the user.

8. The information processing apparatus according to claim 1, wherein the at least one processor executes instructions in the memory device to designate a position from among the plurality of positions in accordance with an instruction issued by a gesture of the user.

9. The information processing apparatus according to claim 1, wherein the at least one processor executes instructions in the memory device to designate a position from among the plurality of positions in accordance with an instruction issued by voice of the user.

10. The information processing apparatus according to claim 1, wherein the at least one processor executes instructions in the memory device to designate a position from among the plurality of positions in accordance with an instruction issued with a ray extending from a hand of the user or a ray extending from a controller.

11. The information processing apparatus according to claim 1, wherein the at least one processor executes instructions in the memory device to designates a position from among the plurality of positions in accordance with an instruction issued by a line of sight of the user.

12. The information processing apparatus according to claim 1, wherein the at least one processor executes instructions in the memory device to:
obtain position information and posture information indicating a position and a posture of the user;
record the position information and the posture information obtained in association with the real image when the real image is obtained; and
generate the pseudo image using the real image recorded in association with the position information indicating the position designated.

13. The information processing apparatus according to claim 1, wherein the information processing apparatus is a head mounted display including the image capturing device and the display device.

14. The information processing apparatus according to claim 1, further comprising:
the image capturing device; and
the display device.

15. The information processing apparatus according to claim 14, wherein the image capturing device is a camera held by the user.

16. The information processing apparatus according to claim 14, wherein the image capturing device is a 360-degree camera.

17. A control method for an information processing apparatus, the control method comprising:
obtaining a current position of a user;
presenting a plurality of positions including the current position with a display device;
designating a position from among the plurality of positions in accordance with an instruction from a user;
displaying an image obtained by an image capturing device capturing a real space as a real image indicating a visual field of the user at the current position on the display device in a case where the position designated is the current position; and
displaying a pseudo image generated by resembling a visual field of the user at the position designated on the display device in a case where the position designated is not the current position.

18. The control method according to claim 17, further comprising:
rendering a computer graphic image in which a virtual object coming in a visual field of the user at the position designated is represented;
displaying a mixed reality image as a real image indicating the visual field of the user at the current position using an image obtained by an image capturing device capturing a real space and the computer graphic image on the display device in a case where the position designated is the current position; and
displaying a mixed pseudo image obtained by combining the pseudo image and the computer graphic image on the display device in a case where the position designated is not the current position.

19. A non-transitory computer-readable storage medium storing a control program causing a computer to execute a control method for an information processing apparatus, the control method comprising:
obtaining a current position of a user;
presenting a plurality of positions including the current position with a display device;
designating a position from among the plurality of positions in accordance with an instruction from a user;
displaying an image obtained by an image capturing device capturing a real space as a real image indicating a visual field of the user at the current position on the display device in a case where the position designated is the current position; and
displaying a pseudo image generated by resembling a visual field of the user at the position designated on the display device in a case where the position designated is not the current position.

20. The non-transitory computer-readable storage medium according to claim 19, wherein the control method further comprising:
rendering a computer graphic image in which a virtual object coming in a visual field of the user at the position designated is represented;
displaying a mixed reality image as a real image indicating the visual field of the user at the current position using an image obtained by an image capturing device capturing a real space and the computer graphic image on the display device in a case where the position designated is the current position; and
displaying a mixed pseudo image obtained by combining the pseudo image and the computer graphic image on the display device in a case where the position designated is not the current position.
